(19) United States
(12) Patent Application Publication
(10) Pub. No.: US 2006/0239563 A1
(43) Pub. Date: Oct. 26, 2006

(54) Method and device for compressed domain video editing

(75) Inventors: Fehmi Chebil, Irving, TX (US); Ragip Kurceren, Carrollton, TX (US); Asad Islam, Richardson, TX (US); Soren Friis, Kangasala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/115,088

(22) Filed: Apr. 25, 2005

(51) Int. Cl. G06K 9/36; H04N 11/02

(52) U.S. Cl. 382/232; 348/384.1

(57) ABSTRACT

When a video stream is edited in compressed domain to achieve video editing effects, the edited bitstream may violate the receiver buffer fullness requirement. In order to comply with the buffer fullness requirement, buffer parameters in the bitstream and the file format are adjusted to ensure that the buffer will not become underflow or overflow due to video editing. As such, re-encoding the entire bitstream is not needed. If the editing effect is a slow-motion effect, a fast motion effect or a black-and-white effect, the buffer parameter to be adjusted can be the transmission rate. If the editing effect is a black-and-white effect, a cutting effect, a merging effect or a fading effect, the compressed frame sized can be adjusted.

### FIELD OF THE INVENTION

The present invention relates generally to video editing and, more particularly, to video editing in the compressed or transform domain.

### BACKGROUND OF THE INVENTION

Digital video cameras are increasingly spreading among the masses. Many of the latest mobile phones are equipped with video cameras offering users the capabilities to shoot video clips and send them over wireless networks.

To allow users to generate quality video at their terminals, it is imperative to provide video editing capabilities to electronic devices, such as mobile phones, communicators and PDAs, that are equipped with a video camera. Video editing is the process of modifying available video sequences into a new video sequence. Video editing tools enable users to apply a set of effects on their video clips aiming to produce a functionally and aesthetically better representation of their video.

In prior art, video effects are mostly performed in the spatial domain. More specifically, the video clip is first decompressed and then the video special effects are performed. Finally, the resulting image sequences are re-encoded. The major disadvantage of this approach is that it is significantly computationally intensive, especially the encoding part.

For illustration purposes, let us consider the operations performed for introducing fading-in and fading-out effects to a video clip. Fade-in refers to the case where the pixels in an image fade to a specific set of colors. For instance, the pixels get progressively black. Fade-out refers to the case where the pixels in an image fade out from a specific set of colors such as they start to appear from a complete white frame. These are two of the most widely used special effects in video editing.

To achieve these effects in the spatial domain, once the video is fully decoded, the following operation is performed:
\tilde{V}(x,y,t)=α(x,y,t)V(x,y,t)+β(x,y,t) (1)
Where V(x,y,t) is the decoded video sequence, \tilde{V}(x,y,t) is the edited video, α(x,y,t) and β(x,y,t) represent the editing effects to be introduced. Here x,y are the spatial coordinates of the pixels in the frames and t is the temporal axis.

In the case of fading a sequence to a particular color C, α(x,y,t), for example, can be set to

$$α ( x , y , t ) = \frac{C}{V ( x , y , t )} . \qquad ( 2 )$$

In the PC platform environment, processing power, storage and memory constraints are not an issue. Video editing can be operated on video sequences in their raw formats in the spatial domain. Video editing in the spatial domain, however, may not be suitable on small portable devices, such as mobile phones, where low resources in processing power, storage space, available memory and battery power are usually of major constraints in video editing. A more viable alternative is compressed domain video editing.

Compressed domain video editing is known in the past. Various schemes have been used to meet the buffer requirements during editing. For example, Koto et al. (U.S. Patent Application No. 6,314,139) discloses a method for editable point insertion wherein coding mode information, VBV (Video Buffering Verifier) buffer occupancy information and display field phase information are extracted from time to time to determine whether conditions for editable point insertion are satisfied, and wherein editable point insertion is delayed until the conditions are satisfied. Egawa et al. (“Compressed domain MPEG-2 video editing with VBV requirement”, Proceedings, 2000 International Conference on Imaging Processing, Vol. 1, 10-13 September 2000, pp. 1016-1019) discloses a method of merging of two video sub-stream segments in CBR (constant bit-rate) and VBR (variable bit-rate) modes. In some cases, zero bits are inserted between the two segments to avoid VBV underflow. In other cases, a waiting period is applied between the entering of one of segments into VBV in order to avoid VBV overflow. Linzer (U.S. Pat. No. 6,301,428) discloses a method of re-encoding a decoded digital video signal based on the statistical values characterizing the previously compressed digital video signal bitstream so as to comply with the buffer requirement. Linzer also discloses a method of choosing an entry point when splicing two compressed digital video bitstreams. Acer et al. (U.S. Pat. No. 6,151,359) discloses a method of synchronizing video data buffers using a parameter in a MPEG standard based on the encoder buffer delay and the decoder buffer delay. Goh et al. (WO 02/058401) discloses a method of controlling video buffer verifier underflow and overflow by changing the quantization step size based on the virtual buffer-fullness level according to MPEG-2 standard. The prior art methods are designed to be in compliance with the buffer requirement in MPEG-2 standard.

It is advantageous and desirable to provide a method and device for video editing in a mobile device to achieve several editing effects such as cutting video, merging (splicing) sequences with/without transition effects, introducing appealing visual effects on videos (such as black and white effect), modifying the speed of a clip (slow or fast motion), etc. In particular, the video editing techniques are in compliance with the buffer requirements in H.263, MPEG-4 and 3GPP standards. These standards define a set of requirements to ensure that decoders receiving the generated bitstreams would be able to decode them. These requirements consist of models defining a set of rules and limits to verify that the amount of memory and processing capacity required for a specific type of decoding resource is within the value of the corresponding profile and level specification.

The MPEG-4 Visual Standard specifies three normative verification models, each one defining a set of rules and limits to verify that the amount required for a specific type of decoding resource is within the value of the corresponding profile and level specification. These models are: the video rate buffer verifier (to ensure that the bitstream memory required at the decoder does not exceed the value defined in the profile and level); the video complexity verifier (the computational power defined in MBs/s required at the decoder does not exceed the values specified within the profile and level) and the video reference memory verifier (picture memory required for decoding a scene does not exceed the values defined in the profiles and levels).

The buffering requirements are nearly identical for the VBV buffering model specified in the MPEG-4 standard and PSS Annex G buffering model. Both models specify that the compressed frames are removed according to the decoding timestamps associated with the frames. The main difference is that the VBV model specifies that the compressed frames are extracted instantaneously from the buffer whereas the Annex G model extracts them gradually according to the peak decoding byte rate and the decoding macroblock rate. However, for both models the compressed frame must be completely extracted before the decoding time of the following frame and the exact method of extraction, therefore, has no impact on the discussion below.

Another difference between the VBV model and the Annex G model is the definition of a post-decoder buffer in Annex G. For most bitstreams the post-decoding period will be equal to zero and post-decoding buffering is therefore not used. For bitstreams using post-decoding buffering the buffering happens after the decoding (i.e. after the extraction of the compressed frames from the pre-decoder buffer) and it has no impact on the discussion below.

The HRD (Hypothetical Reference Decoder) buffering model defined in the H.263 standard behaves somewhat differently than the VBV and Annex G buffering models. Instead of extracting the compressed frames at their decoding time, the frames are extracted as soon as they are fully available in the pre-decoder buffer. The main impact of this is that, without external means, a stand-alone decoder with full access to the bitstream would decode the streams as fast as the decoder is capable of. However, in real systems this will not happen. For local playback use cases, displaying the decoded frames will always be synchronized against the timestamps in the file container in which the bitstream is embedded (and/or against the associated audio). For streaming or conversational use cases the decoder will not have access to the compressed bitstream before it has been received via the transmission channel. Since the channel bandwidth is typically limited and the transmitter can control how fast the bitstream is submitted to the channel, decoding will typically happen at a pace approximately equal to the situation where the decoder uses the timestamps to extract the compressed frames from the buffer. Thus, for both situations it can be assumed that the decoder behaves approximately equally to the behavior defined in the VBV and Annex G buffering models. The discussion below is therefore valid also for the H.263 HRD.

One other difference between the H.263 HRD and the MPEG-4 VBV models is that the HRD does not define any initial buffer occupancy. It is therefore not possible to modify this value for H.263 bitstreams generated according to the HRD model.

The H.263 standard defines one extra condition compared to the MPEG-4 standard. From section 3.6 of the H.263 specification:
NumberOfBits/frame≦BPPₘₐₓKb

For instance, in QCIF sized video BPPₘₐₓKb=64×1024=8.92 KByte.

In this disclosure, the encoder is restricted to generate a maximum of Kₘₐₓ bytes/frame such that
Kₘₐₓ≦BPPₘₐₓ

All of the video coding standards as mentioned above define a set of requirements to ensure that decoders receiving the generated bitstreams would be able to decode them. These requirements consist of models defining a set of rules and limits in order to verify that the amount of memory and processing capacity required for a specific type of decoding resource is within the value of the corresponding profile and level specification. Therefore, compressed domain editing operations should also consider the compliancy of the edited bitstreams. The present invention provides novel schemes in compressed domain to address the compliancy of the edited bitstreams.

### SUMMARY OF THE INVENTION

The present invention relates to buffer compliancy requirements of a video bitstream edited to achieve a video editing effect. When a video stream is edited in compressed domain, the edited bitstream may violate the receiver buffer fullness requirement. In order to comply with the buffer fullness requirement, buffer parameters in the bitstream and the file format are adjusted to ensure that the buffer will not become underflow or overflow due to video editing. As such, re-encoding the entire bitstream is not needed. If the editing effect is a slow-motion effect, a fast motion effect or a black-and-white effect, the buffer parameter to be adjusted can be the transmission rate. If the editing effect is a black-and-white effect, a cutting effect, a merging effect or a fading effect, the compressed frame sized can be adjusted.

Thus, the first aspect of the present invention provides a method for use in video editing for modifying at least one video frame in a video stream in order to achieve at least one video editing effect, the video editing carried out in a receiver receiving video data in the video stream, the receiver having a buffer for storing the received video data for decoding so as to allow the video stream to be played out, the buffer having a buffer fullness requirement, wherein the video data is received and played out based on a plurality of parameters such that the receiver buffer is prevented from violating of the buffer fullness requirement, and wherein the video editing effect affects the receiving and playing of the video data. The method comprises the steps of:

selecting at least one video editing effect; and

adjusting at least one of the parameters based on the selected at least one video editing effect so that video data is received and played out in compliance with the buffer fullness requirement, wherein said adjusting is carried out before modifying said one or more video frames in compressed domain for achieving the selected at least one video editing effect.

According to the present invention, the parameters to be adjusted include a transmission rate for transmitting the video data to the receiver receiving the video stream, and the selected editing effect is selected from a slow motion effect, a fast motion effect and a black-and-white effect, and wherein said adjusting comprises a modification in the transmission rate. The selected editing effect is achievable by decoding the stored video data at an adjusted decoding rate, and the modification in the transmission rate is at least partly based on the adjusted decoding rate.

According to the present invention, the parameters to be adjusted include a compressed frame size of the video frame, and the selected editing effect is selected from a black-and-white effect, a cutting effect, a merging effect and a fading effect, and wherein said adjusting comprises a modification in the compressed frame size. The selected editing effect is the merging effect achievable by adding video data to be merged into the video stream, and the modification is at least partly based on the added video data. Furthermore, the selected editing effect is the fading effect achievable by adding data of at least one color into the video stream, and the modification is at least partly based on the added video data. Likewise, the selected editing effect is the black-and-white effect achievable by removing at least a portion of video data from the video stream, and the modification is at least based on the removed portion of the video data.

A second aspect of the present invention provides a video editing module for use in an electronic device for changing at least one video frame in a video stream in order to achieve at least one video editing effect, the video stream including video data received in the electronic device, the electronic device having a buffer for storing the received video data for decoding so as to allow the video stream to be played out, the buffer having a buffer fullness requirement, wherein the video data is received and played out based on a plurality of parameters such that the buffer is prevented from violating the buffer fullness requirement, and wherein the video effect affects the receiving and playing of the video data. The video editing module comprises:

a video editing engine, based on a selected video editing effect, for adjusting at least one of the parameters so that video data is received and played out in compliance with the buffer requirement, and

a compressed-domain processor, based on the selected video editing effect, for modifying said one or more video frames, wherein said adjusting is carried out before said modifying.

According to the present invention, the video editing module further comprises:

a composing means, responsive to the modified one or more video frames, for providing video data in a file format for playout.

According to the present invention, the parameters to be adjusted include a transmission rate for transmitting the video data to the receiver receiving the video stream, the selected editing effect is selected from a slow motion effect, a fast motion effect and a black-and-white effect, and said adjusting comprises a modification in the transmission rate, and a compressed frame size of the video frame, and the selected editing effect is selected from a black-and-white effect, a cutting effect, a merging effect and a fading effect, and said adjusting comprises a modification in the compressed frame size.

A third aspect of the present invention provides a video editing system for use in an electronic device for changing at least one video frame in a video stream in order to achieve at least one video editing effect, the video stream including video data received in the electronic device, the electronic device having a buffer for storing the received video data for decoding so as to allow the video stream to be played out, the buffer having a buffer fullness requirement, wherein the video data is received and played out based on a plurality of parameters such that the buffer is prevented from violating the buffer fullness requirement, and wherein the video effect affects the receiving and playing of the video data. The video editing system comprises:

means for selecting at least one video editing effect;

a video editing engine, based on the selected video editing effect, for adjusting at least one of the parameters so that video data is received and played out in compliance with the buffer requirement; and

a compressed-domain processor, based on the selected video editing effect, for modifying said one or more video frames, wherein said adjusting is carried out before said modifying.

According to the present invention, the video editing system further comprises:

a composing module, responsive to the modified one or more video frames, for providing further video data in a file format for playout, and

a software program, associated with the video editing engine, having codes for computing the transmission rate and the compressed frame size to be adjusted based on the selected video editing effect and current transmission rate and compressed frame size so as to allow the video editing engine to adjust said at least one of the parameters based on said computing.

A fourth aspect of the present invention provides a software product for use in video editing for modifying at least one video frame in a video stream in order to achieve at least one video editing effect, the video editing carried out in a receiver receiving video data in the video stream, the receiver having a buffer for storing the received video data for decoding so as to allow the video stream to be played out, the buffer having a buffer fullness requirement, wherein the video data is received and played out based on a plurality of parameters such that the receiver buffer is prevented from violating the buffer fullness requirement, said plurality of parameters including a transmission rate and a compressed frame size, and wherein the video editing effect affects the receiving and playing of the video data, the software product comprising a computer readable medium having executable codes embedded therein, said codes, when executed, adapted for:

computing at least one of the parameters to be adjusted for conforming with the buffer fullness requirement based on a selected video editing effect and on current transmission rate and compressed frame size, and

providing said computed parameter so that the video data is received and played out at least based on said computed parameters before modifying said one or more video frames in compressed domain for achieving the selected at least one video editing effect.

A fifth aspect of the present invention provides an electronic device comprising:

means for receiving a video stream having video data included in a plurality of video frames;

a buffer for storing the received video data for decoding so as to allow the video stream to be played out, the buffer having a buffer fullness requirement;

a video editing module for modifying at least one video frame in the video stream in compressed domain in order to achieve at least one selected video editing effect, wherein the video data is received and played out based on a plurality of parameters such that the buffer is prevented from violating the buffer fullness requirement, and wherein the video effect affects the receiving and playing of the video data, and

means, based on the selected video editing effect, for computing at least one of the parameters to be adjusted so that video data is received and played out in compliance with the buffer fullness requirement, wherein the adjustment of said at least one of the parameters is carried out before said modifying.

### BRIEF DESCRIPTION OF THE DRAWINGS

FIG. 1 is a schematic representation showing a buffering model for a video sequence when the buffer requirements are not violated.

FIG. 2 is a schematic representation showing the effect of slow motion on a video sequence, wherein the buffer requirements are violated.

FIG. 3 is a schematic representation showing the effect of slow motion, wherein the buffer requirements are met.

FIG. 4 is a schematic representation showing the effect of fast motion on a video sequence, wherein the buffer requirements are violated.

FIG. 5 is a schematic representation showing the effect of fast motion, wherein the buffer requirements are met.

FIG. 6a is a schematic representation showing the original behavior of a sequence before a frame is withdrawn to achieve a black-and-white video effect.

FIG. 6b is a schematic representation showing the effect of black-and-white operation on a video sequence, wherein the buffer requirements are violated.

FIG. 7 is a schematic representation showing the effect of black and white operation, wherein the buffer requirements are met.

FIG. 8a is a schematic representation showing cutting points on a video sequence in a clip cutting operation.

FIG. 8b is a schematic representation showing the video sequence after the clip cutting operation.

FIG. 9 is a schematic representation showing the effect of cutting of a video sequence and how the buffer requirements can be met.

FIG. 10a is a schematic representation showing the buffer model of one of two video sequences to be merged, wherein the buffer requirements are met.

FIG. 10b is a schematic representation showing the buffer model of the other video sequence to be merged, wherein the buffer requirements are met.

FIG. 10c is a schematic representation showing the effect of merging two video sequences, resulting in a violation of buffer requirements.

FIG. 11 is a block diagram illustrating a typical video editing system for mobile devices.

FIG. 12 is a block diagram illustrating a video processor system, according to the present invention.

FIG. 13 is a block diagram illustrating a spatial domain video processor.

FIG. 14 is a schematic representation showing a portable device, which can carry out compressed domain video editing, according to the present invention.

FIG. 15 is a block diagram illustrating a media coding system, which includes a video processor, according to the present invention.

### DETAILED DESCRIPTION OF THE INVENTION

The PSS Annex G model is mainly used together with H.263 bitstreams to overcome the limitations that the HRD (Hypothetical Reference Decoder) set on the bitstream. For MPEG-4 bitstreams it may not be useful to follow the Annex G model because the Annex G model is similar to the VBV model.

In order to satisfy other requirements shared by the HRD (H.263), the VBV (MPEG-4) and the PSS Annex G buffering models, the following dual conditions must be satisfied:
0≦B(n+1)≦B_{VBV} (3)
0≦B*(n+1)≦B_{VBV} (4)
where

B_{VBV} is the buffer size;

$$\begin{matrix}B ( n + 1 ) = {B}^{*} ( n ) + {\int }_{n}^{{t}_{n + 1}} R ( t ) ⅆ t & ( 5 ) \\ {B}^{*} ( n + 1 ) = {B}^{*} ( n ) + {\int }_{n}^{{t}_{n + 1}} R ( t ) ⅆ t - {ⅆ}_{n + 1} & ( 6 )\end{matrix}$$

dₙ is the frame data needed to decode frame n at time tₙ.

B(n) is the buffer occupancy at the instance tₙ (relevant to frame n);

B*(n) is the buffer occupancy after the removal of dₙ from B(n) at the instance t*ₙ; and

R(t) is the rate at which data arrives at the decoder whether it is streamed (bandwidth) or it is read from memory.

From Equation 5 and Equation 6, we have
B*(n+1)+dₙ+1=B(n+1)
These dual conditions are met at the same time only if the following condition is true:

$${d}_{n + 1} \leq {B}^{*} ( n ) + {\int }_{n}^{{t}_{n + 1}} R ( t ) ⅆ t \leq {B}_{VBV} \qquad ( 7 )$$

If the rate is constant, then

$${\int }_{n}^{{t}_{n + 1}} R ( t ) ⅆ t = R Δ t \\ where \\ Δ {t}_{n} = {t}_{n + 1} - {t}_{n} \qquad ( 8 )$$

and Equation 7 becomes:
dₙ+1≦B*(n)+RΔtₙ≦B_{VBV}

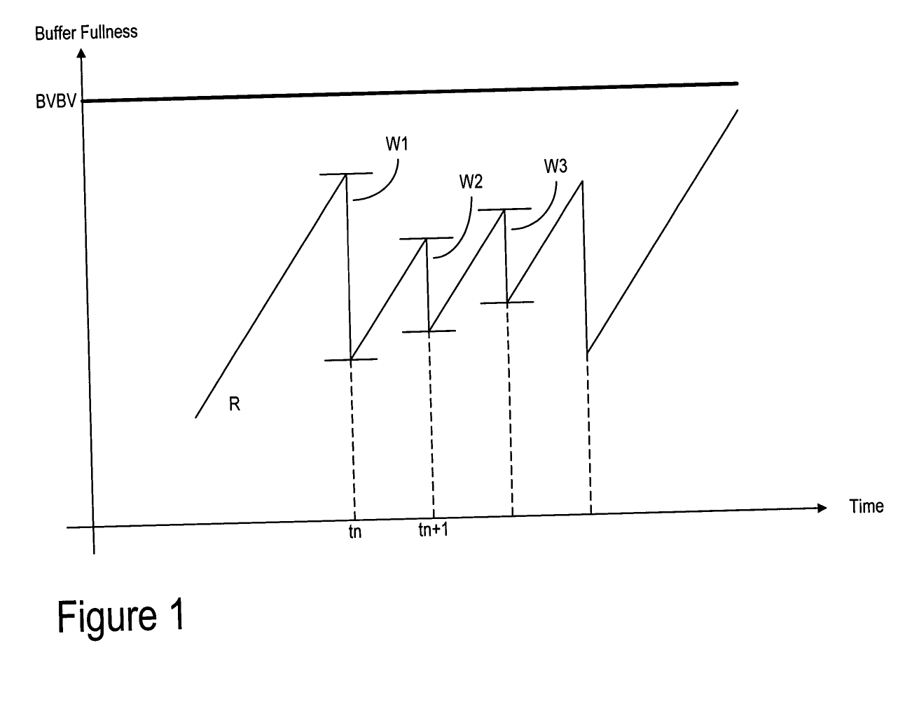

For editing applications in a mobile video editor, the process starts from a sequence (or a set of sequences) V, satisfying Equation 7. The video sequence behaves in a manner as shown in FIG. 1.

After editing the sequence with an effect, the modified sequence Vₑ must also satisfy the same buffer requirement:
dₑ_{ₙ₊₁}≦Bₑ*(n)+RₑΔtₙ≦Bₑ_{_{VBV}} for each n (9)
The subscript e denotes the edited sequence and related parameters.

Referring to Equation 9, we have five parameters to control in order to satisfy the buffer requirements:

Rₑ=the transmission rate.

dₑ=the compressed frame size.

Bₑ=the buffer fullness for the previous frame (depending on the size of the buffer, the initial buffer occupancy, and the characteristics of the bitstream so far).

Bₑ_{_{VBV}}=the size of the buffer, which is restricted by the level in use, and

Δtₙ=the time difference between two consecutive video frames.

To relate these parameters with what the MPEG-4 standard defines, the codestream in the Video Object Layer (VOL) header includes the following three parameters for the VBV model:
vbv_buffer_size: The minimum bitstream memory required at the decoder to properly decode the corresponding codestream;
vbv_occupancy: Initial occupancy: The occupancy that the VBV must reach in order that the decoding process may start with the removal of the first frame (default is ⅔ of the defined buffer size)=>together with the bit rate parameter this defines the initial decoding delay known as the VBV latency, and
bit_rate: an upper bound on the bit rate that the data is arriving at the decoder.

It should be noted, however, that these parameters cannot be specified in the bitstream according to the H.263 standard. Instead, they can be specified in the file-format container (e.g. the 3GP or the MP4 file-format) or in the session negotiation for video streaming.

For bitstreams compliant with the PSS Annex G buffering model the parameters can be specified in the file-format container (e.g. the 3GP file-format) or in the session negotiation for video streaming.

As previously mentioned, typical video editing includes the slow motion effect, fast motion effect, black-and-white effect, merging effect and fading effect. Because each of these effects may affect the video buffer in a different way, the methods for satisfying the buffer requirements in these effects are separately discussed.

In each of the methods used in video editing, it is assumed that the initial video sequence meets the buffer requirements. The buffer model for the initial video sequence is schematically shown in FIG. 1. The sequence includes a number of frames separated by a frame time tₙ. The slope of the curve between two frame times represents the transmission rate R, and the decreased amount at the beginning of a frame time is the size of the frame (w₁, w₂, for example) withdrawn from the buffer so it can be decoded.

It should be noted that, however, Bₑ is also mainly controlled by the initial buffer occupancy, Bₒ. In general, in order to satisfy the buffer requirements as given in Equation 9, at least one of the four parameters: Rₑ, dₑ, Bₒ and Bₑ_{_{VBV}} must be modified. This depends very much on the characteristics of the bitstreams. For some bitstreams, it may not be possible to find an initial buffer occupancy value that avoids overflow and underflow. Changing Bₑ_{_{VBV}} requires modification at a higher level and this technique may not be suitable for video editing in a portable device, for example. Furthermore, in video editing involving the black-and-white effect, the chrominance data could theoretically lead the buffering to infinity.

Slow Motion Effect

In video editor applications, the slow motion effect can be introduced into the sequence by altering the timestamps at the file format level and the temporal reference values at the codestream level, i.e., Δtₙ.

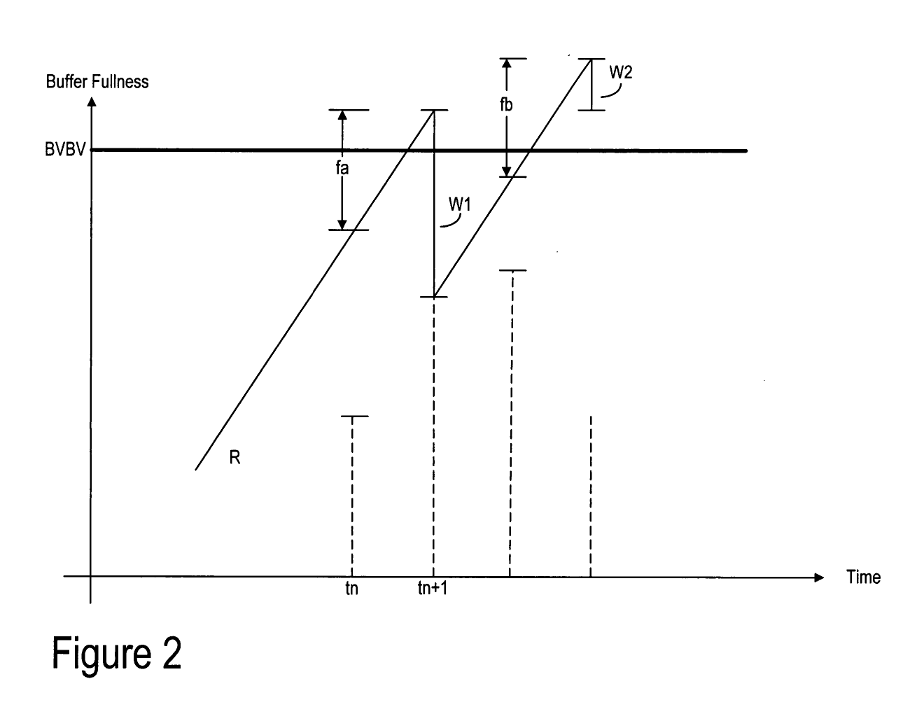

FIG. 2 shows how the slow motion effect affects the behavior of the buffering at the decoder side. Comparing this behavior to the buffer model of the video sequence as shown in FIG. 1, it can be seen that a new frame, fₐ, arrives before the withdrawal of frame w₁ for decoding. Likewise, a new frame, f_{b}, arrives before the withdrawal of frame w₂. Because of the arrival of new frames before the buffer is partially cleared, the buffer can overflow if nothing is done in the parameters.

To make it compliant to the buffering requirements, it is possible to change the rate Rₑ or the compressed frame size dₑ. The change in the compressed frame size involves decoding the frame and re-encoding it at a lower bit rate. This may not be a viable approach in a mobile terminal environment.

According to the present invention, the transmission rate is modified in order to satisfy the buffer requirements as set forth in Equation 9. The transmission rate is modified using a slow motion factor, SM, such that

$${R}_{e} = \frac{R}{SM} .$$

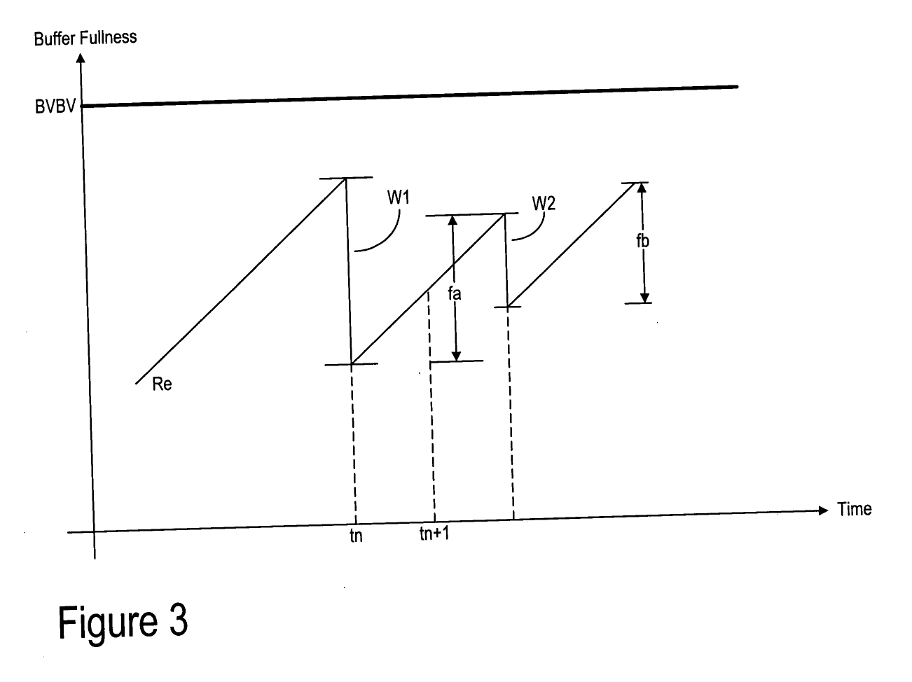

Setting Rₑ to a lower rate can keep the buffer level at the same level before and after the slow motion effect takes place. After modifying the transmission rate, the behavior of the buffering at the decoder side is shown in FIG. 3. As shown in FIG. 3, frame w1 is withdrawn prior to the arrival of the new frame fₐ. Likewise, frame w2 is withdrawn prior to the arrival of the new frame f_{b}. The buffer is no longer overflowed.

If the codestream is MPEG-4 compliant, then the value of the bit_rate in the VOL header can be modified to effect the change. If the codestream is H.263 or Annex G compliant, then the rate is caused to change at the higher protocol layer level, for instance, when negotiating the rate using the SDP (Session Description Protocol).

In summary, the compliancy of the video editing operation for slow-motion in compressed domain can be ensured by updating the transmission rate, Rₑ, in the bitstream/file-format/protocol layer level.

Fast Motion Effect

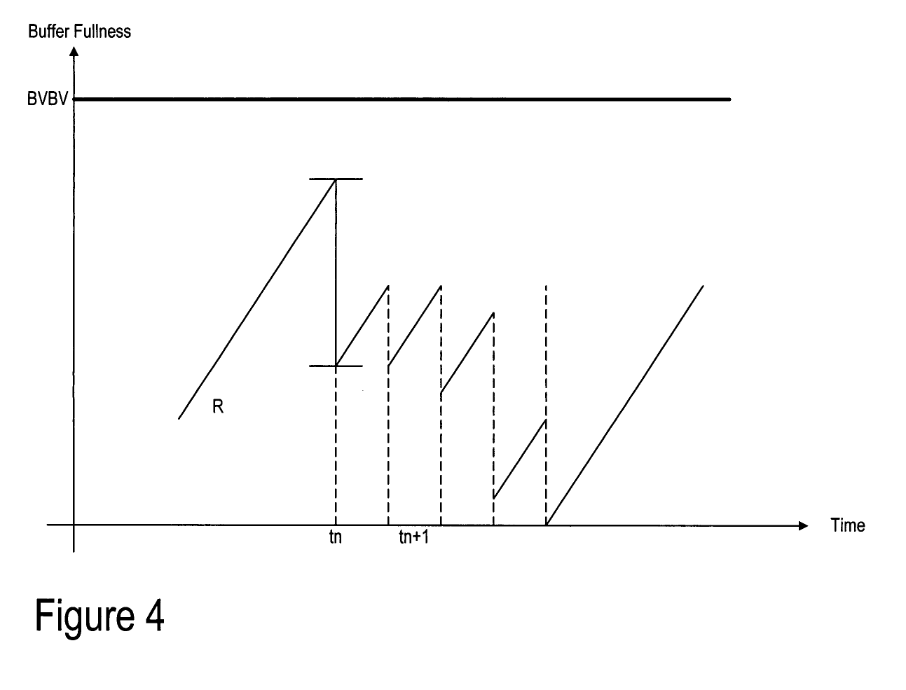

In video editor applications, the fast motion effect to the sequence can be introduced by altering the timestamps at the file format level and the temporal reference values at the codestream level, i.e., Δtₙ. As a consequence of the fast motion effect, more frames are withdrawn for decoding than the replenishment. As shown in FIG. 4, at some point the buffer level reaches zero. The buffer can underflow if nothing is done in the parameters.

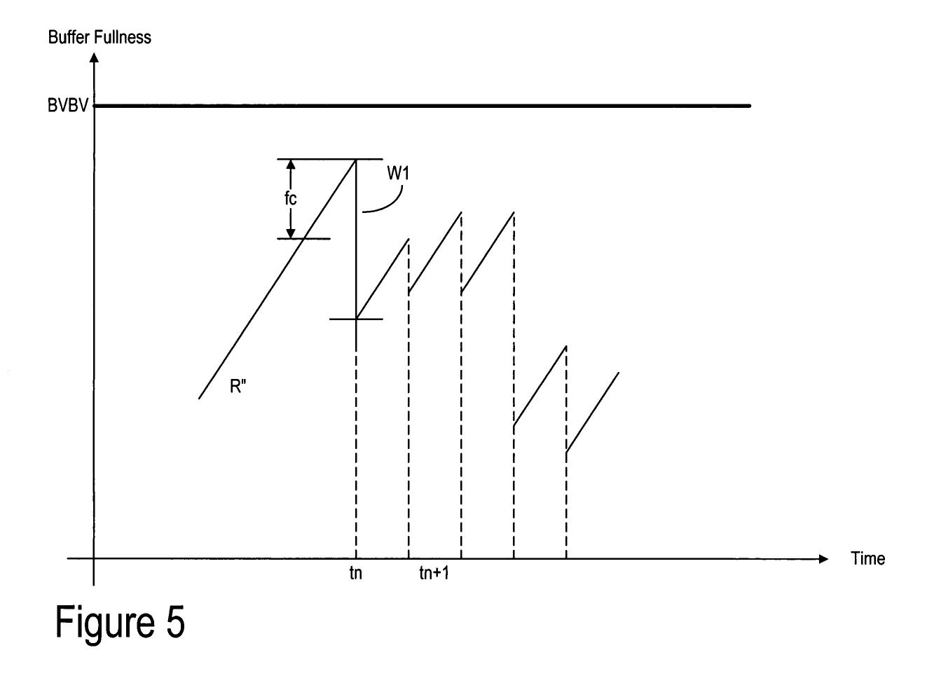

To make the buffer behavior compliant to the buffering requirements, the transmission rate can be modified such that Rₑ=R×FM, where FM is the fast motion factor. Setting Rₑ to a higher bit_rate forces the bitstream to be at a higher level. For example, at certain point in time, a new frame f_{c} arrives prior to the withdrawal of a frame for decoding, as shown in FIG. 5.

If the stream is MPEG-4 compliant, the value of the bit_rate can be changed in the VOL header. In H.263 or Annex G compliant, the rate can be changed at the higher protocol layer level, for instance, when negotiating the rate using the SDP.

It is highly likely that the required level for the edited sequence will be higher than the un-edited sequence. However, since this effect essentially increases the frame-rate of the sequence (e.g. by a factor two) the decoder also has to decode faster. This is only possible if the decoder is conformant with the higher level.

In summary, the compliancy of the video editing operation for fast-motion in compressed domain can also be ensured by updating the transmission rate, Rₑ, in the bitstream/file-format/protocol layer level.

Black and White Effect

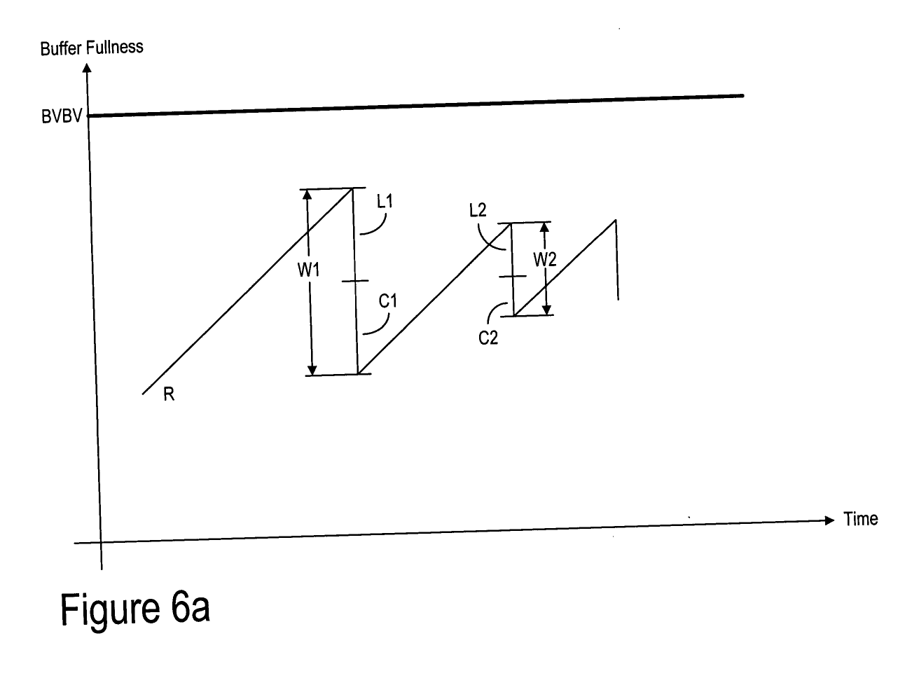

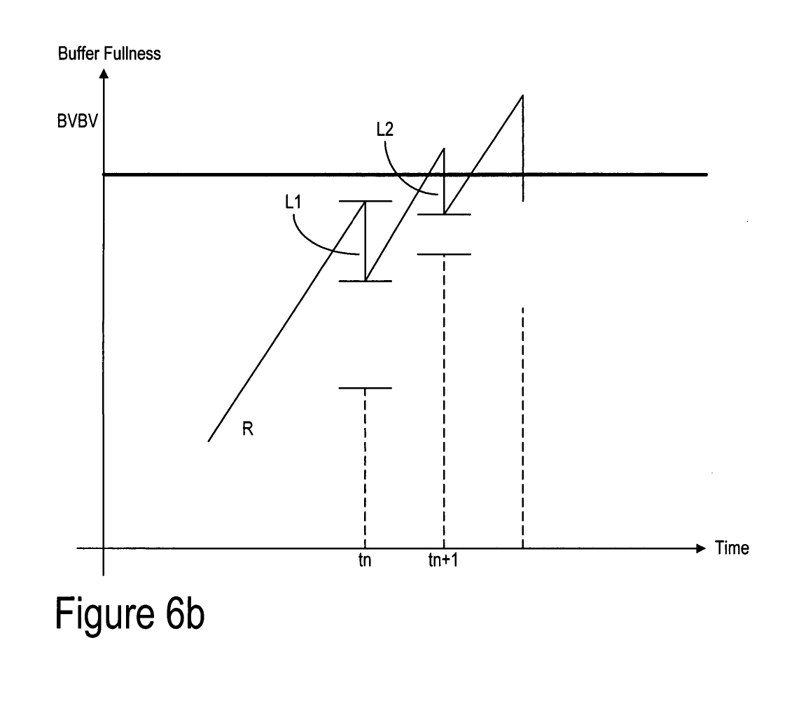

In video editor applications, the black and white effect can be introduced into the sequence by removing the chrominance components from the compressed codestream. For comparison purposes, the original behavior of the sequence is depicted in FIG. 6a. The frame to be withdrawn, w₁, consists of a luminance data amount L₁ and a chrominance data amount C₁. Likewise, the other frame to be withdrawn, w₂, consists of a luminance data amount L₂ and a chrominance data amount C₂. In a black-and-white operation, the chrominance data amount no longer exists. If the parameters are not changed when buffering the compressed stream, the buffer requirements can be violated, as shown in FIG. 6b.

To make it compliant to the buffering requirements, the transmission rate can be modified such that

$${R}_{e} = \frac{R \times average\_frame \_size \_with \_no \_chroma}{average\_original \_framesize}$$

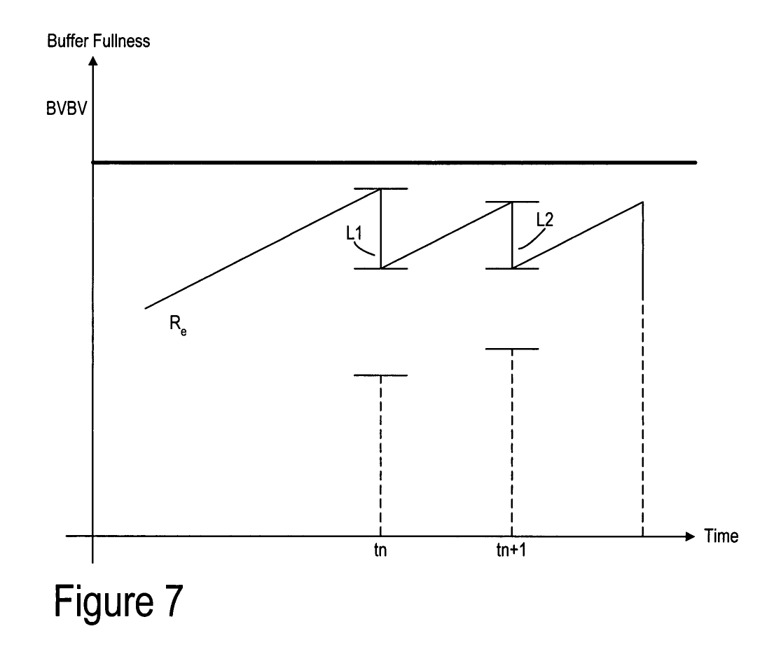

This is equivalent to decreasing the rate by a fraction representing the portion of chrominance data in the codestream. As such, the buffer requirements can be met, as illustrated in FIG. 7. It should be noted that, in FIGS. 6a, 6b and 7, the chrominance data amount is low as compared to the luminance data amount. However, this situation can happen.

Alternatively, stuffing data can be inserted in the bitstream in order to replace the removed chrominance data amount. That is, dₑ is changed by inserting stuffing data so that dₑ=dₙ. (dₙ is the size of the video frame before the editing, i.e., the video size before and after editing is kept the same by removing the chroma information by replacing with stuffing bits.)

In the first approach, if the stream is MPEG-4 compliant, the value of the bit_rate can be changed in the VOL header. If the stream is H.263 or Annex G compliant, the rate can be changed at the higher protocol layer level, for instance when negotiating the rate using the SDP.

It should be noted that that, because the amount of chrominance data may vary from frames to frames, the buffer requirement may be violated when the amount of chromainance data for some frames is significantly different from the value of average_frame_size_with_no-chroma.

In the second approach, stuffing can be introduced at the end of the frames in order to fill in for the removed chrominance data. It is necessary to make updates on the edited sequence at the file format level to modify the sizes of the frames.

Alternatively, the first and second approaches can be used in conjunction.

Cutting Operations

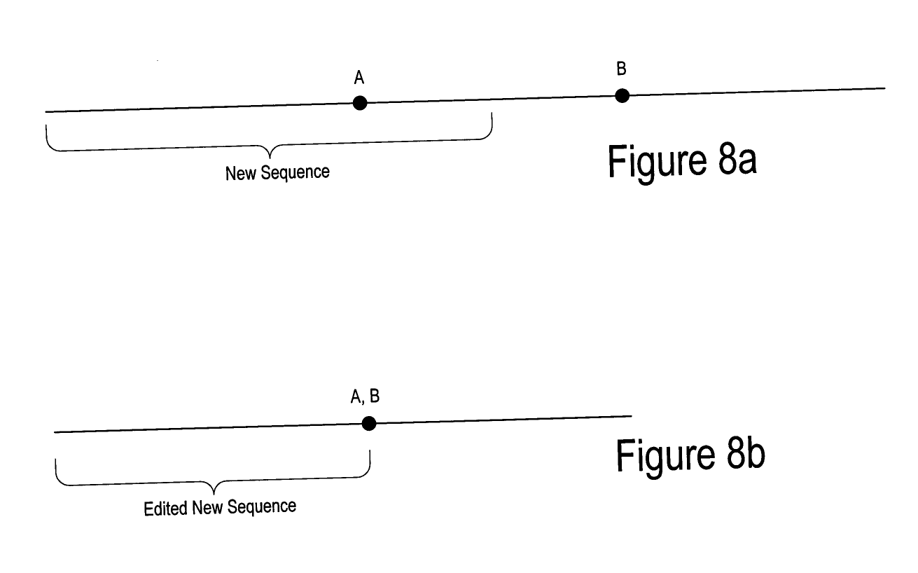

In video editor applications, a video sequence can be cut at any point. As shown in FIG. 8a, a segment is cut from point A to point B in order to remove all of the frames preceding point A from a new sequence and all frames subsequent to point B. As such, the frame at point A becomes the first frame of the edited segment subsequent to point A and the frame at point B becomes the last frame of the edited segment preceding point B. After cutting, the edited frame is shown in FIG. 8b. If the frame at point A has been encoded in an inter-mode P-picture, this frame should be converted into an Intra frame. This is because the decoding of the original frame at point A, which is a P frame, requires the reconstruction of the preceding frames that have been removed.

The main constraint to be satisfied in order to ensure buffer compliancy is as follows:
B_{A}^{B}*(n)=B_{A}^{A}*(n)=Bₒₑ−d_{A}
where

B_{A}^{B}*(n) is the buffer level after frame A before editing;

B_{A}^{A}*(n) is the buffer level after frame A after editing;

Bₒₑ is the initial buffer occupancy of the edited sequence right before removing the first frame; and

d_{A} is the frame size of A after conversion to Intra picture.

As can be seen from the previous constraint, there are two factors to be modified in order to maintain buffer compliancy: the initial buffer occupancy and the frame size for the first Intra picture.

To make the buffer behavior compliant to the buffering requirements, the converted Infra frame must have a size such that size(I)≦size(P) in order to prevent an overflow. With this approach, it is possible to use the same average Quantization Parameter (QP) value utilized for the original frame and possibly iterate a number of times when encoding the Intra frame to ensure that the target bit rate is achieved. However, it is likely that the visual quality of the resulting Intra frame is lower than the original P frame.

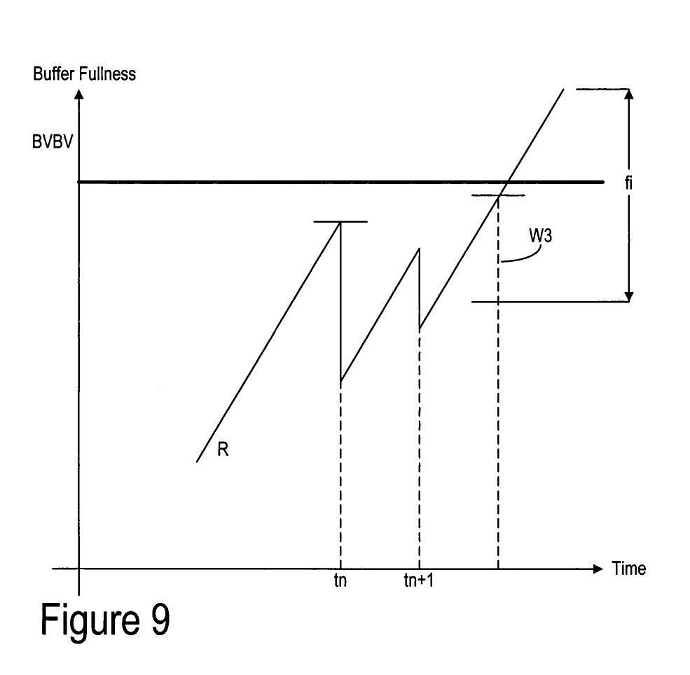

Alternatively, it is possible to increase the delay time waiting for the new intra frame to fill the initial buffer. That is, the initial buffer occupancy level might need to be increased. With this approach, we can modify the VBV parameters at the codestream level. The buffer occupancy level at the instant of the original P frame must be measured and the buffer occupancy level for the truncated bitstream is set equal to this value. FIG. 9 shows how the effect of cutting operation modifies the buffering scheme. The size of the new Intra frame, fᵢ, must be set such that the following conditions are satisfied:
B_{A}^{B}*(n)=B_{A}^{A}*(n)=Bₒₑ−fᵢ
where

B_{A}^{B}*(n) is the buffer level after frame A before editing;

B_{A}^{A}*(n) is the buffer level after frame A after editing; and

Bₒₑ is the initial buffer occupancy of the edited sequence.

It might be necessary to increase the occupancy level if the Intra frame is larger than the P frame. In such case, both approaches should be used in conjunction.

It should be noted that cutting at the end of the sequence should not cause any problem.

Merging Operations with/without Transitions

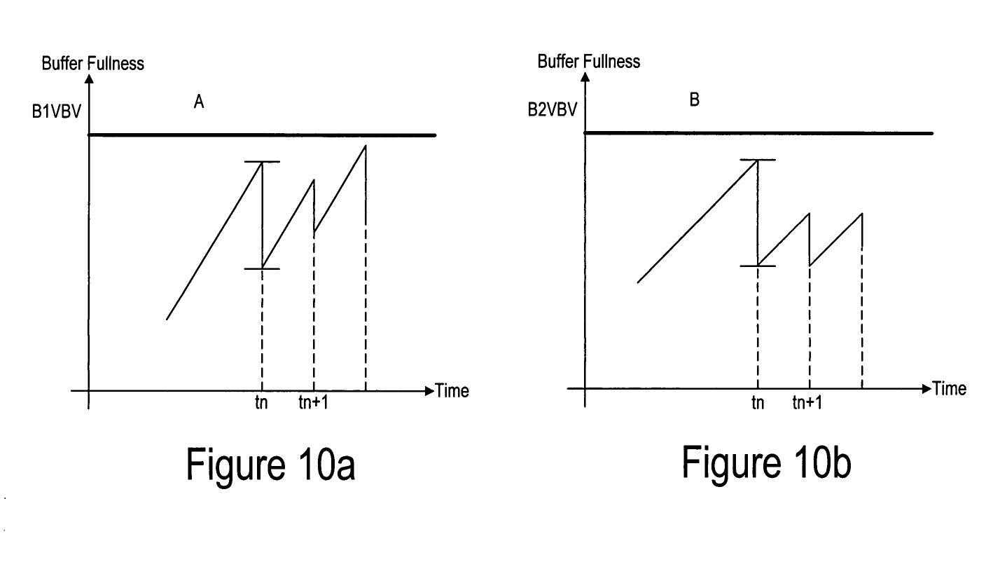

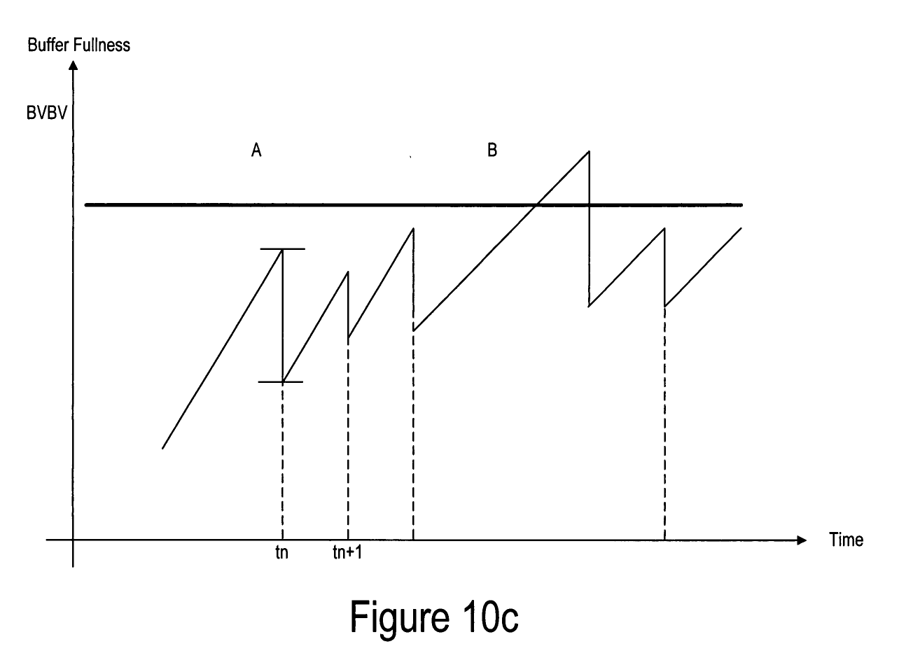

In video editor applications, it is possible to put one video sequence after another by a merging operation. Optionally, a transition effect, such as wipe or dissolve, can be applied. FIGS. 10a and 10b show the two sequences to be merged. Before merging, the buffer model for each sequence is compliant to the buffer requirements. However, the buffer requirements may be violated after merging, as shown in FIG. 10c.

The main constraint to be satisfied in order to ensure buffer compliancy is as follows:
B_{B}^{B}*(n)=B_{B}^{A}*(n)=B_{oB}^{B}−d_{B}^{B}=B_{A}^{A}*(n)+d_{B}^{A}
where

B_{B}^{B}*(n) is the buffer level after the first frame of Sequence B before editing;

B_{B}^{A}*(n) is the buffer level after the first frame of Sequence B after editing;

B_{oB}^{B} is the initial buffer occupancy of Sequence B, before editing;

d_{B}^{B} is the frame size of the first frame of Sequence B before editing;

B_{A}^{A}*(n) is the buffer level after the last frame of Sequence A after editing; and

d_{B}^{A} is the frame size of Sequence B after editing.

It should be noted that there are a number of approaches to ensure buffer compliancy:

I. Controlling B_{A}^{A}(n), the buffer level after the last frame of Sequence A after editing—this can be achieved by re-encoding the last k frames of Sequence A;

II. Controlling d_{B}^{A}, the frame size of Sequence B after editing by converting Intra frame into P-frame if the merged sequences have similar contents.

III. Re-writing the above constraint for a frame at a later point in Sequence B, say k′ frames—this allows the first k′ frames to be re-recorded in order to allow insertion of the large Intra frame.

In order to make the operation compliant to the buffer requirements, it is possible to re-encode the last k frames of the preceding sequence (Sequence A in FIG. 10c) to allow insertion of the large intra frame that starts the subsequent sequence (sequence B).

Alternatively, we can re-encode the first k′ frames of Sequence B to avoid buffer overflow. This approach would affect the visual quality of Sequence B. Furthermore, it is necessary to make sure that the converted Intra-frame has a size such that size(I)≦size(P) in order to prevent a buffer overflow.

The first approach has a lesser impact on the visual quality of the spliced sequence. When transition effects are used, it is always required to re-encode parts of both sequence A and sequence B, which will make it easier to combine both approaches.

It is also possible to increase the delay of Bₑ_{_{VBV}} in order to make the buffer behavior compliant to the buffer requirements. The main disadvantage of this approach is that the buffer size may exceed the limits imposed the level/profile. If the level/profile extension is undesirable (e.g., the decoder does not support higher levels), then such approach may be taken.

Fading In/Out operations

In video editor applications, it is possible to introduce fading operations. A fading operation can be considered as merging a sequence with a clip that has a particular color. For example, fading a sequence to white is similar to merging it with a sequence of white frames. The fading effect is similar to the one presented in merging operations with a transition effect. Thus, the analysis in the merging operations with/without transition is also applicable to the fading operations.

Implementation

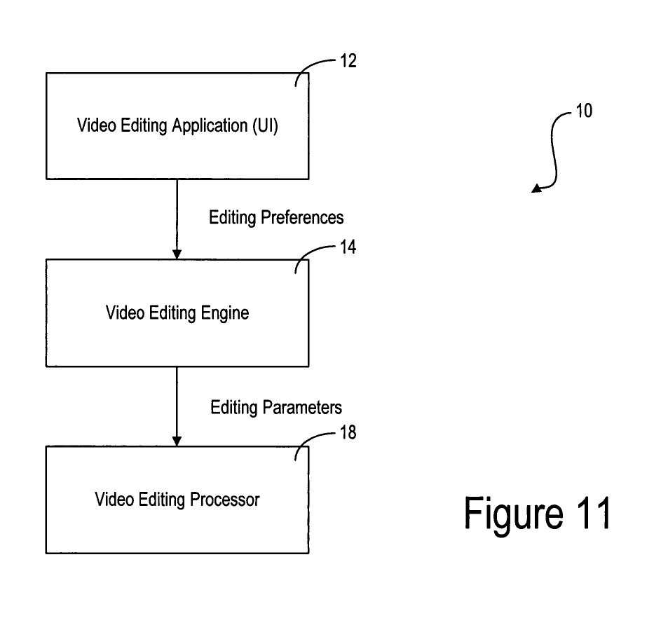

The video editing procedure, according to the present invention, is based on compressed domain operations. As such, it reduces the use of decoding and encoding modules. FIG. 11 illustrates a typical editing system designed for a communication device, such as a mobile phone. This editing system can incorporate the video editing method and device, according to the present invention. The video editing system 10, as shown in FIG. 11, comprises a video editing application module 12 (graphical user interface), which interacts with the user to exchange video editing preferences. The application uses the video editor engine 14, based on the editing preferences defined or selected by the user, to compute and output video editing parameters to the video editing process module 18. The video editing processor module 18 uses the principle of compressed-domain editing to perform the actual video editing operations. If the video editing operations are implemented in software, the video editing processor module 18 can be a dynamically linked library (dll). Furthermore, the video editor engine 14 and the video editing processor 18 can be combined into a single module.

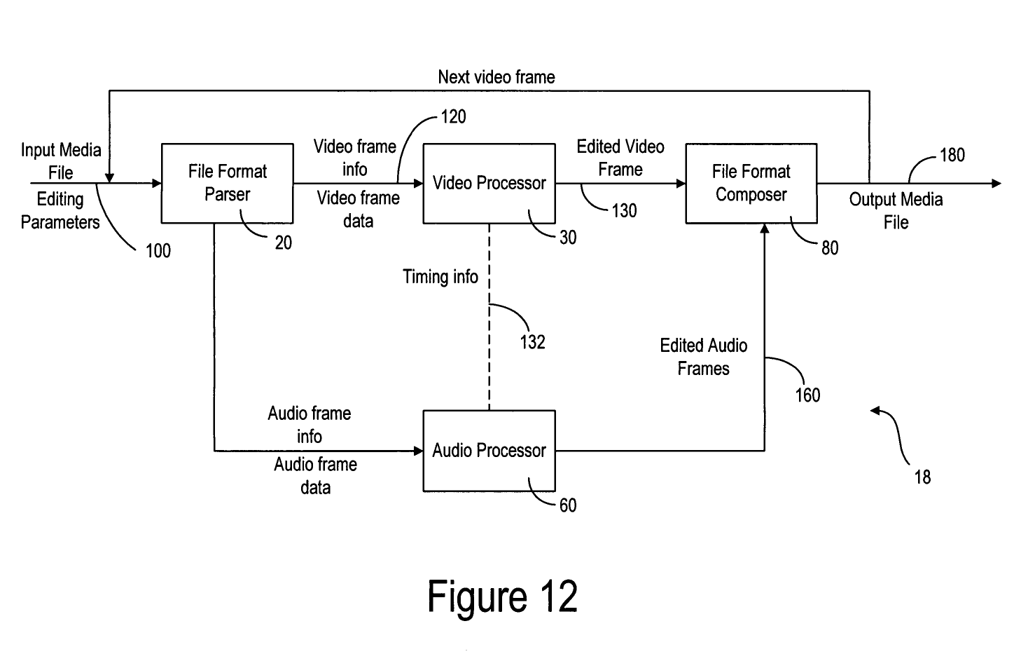

A top-level block diagram of the video editing processor module 18 is shown in FIG. 12. As shown, the editing processor module 18 takes in a media file 100, which is usually a video file that may have audio embedded therein. The editing process module 18 performs the desired video and audio editing operations in the compressed domain, and outputs an edited media file 180. The video editing processor module 18 consists of four main units: a file format parser 20, a video processor 30, an audio processor 60, and a file format composer 80.

A. File Format Parser:

Media files, such as video and audio, are almost always in some standard encoded format, such as H.263, MPEG-4 for video and AMR-NB, CELP for audio. Moreover, the compressed media data is usually wrapped in a file format, such as MP4 or 3GP. The file format contains information about the media contents that can be effectively used to access, retrieve and process parts of the media data. The purpose of the file format parser is to read in individual video and audio frames, and their corresponding properties, such as the video frame size, its time stamp, and whether the frame is an intra frame or not. The file format parser 20 reads individual media frames from the media file 100 along with their frame properties and feeds this information to the media processor. The video frame data and frame properties 120 are fed to the video processor 30 while the audio frame data and frame properties 122 are fed to the audio processor 60, as shown in FIG. 12.

B. Video Processor

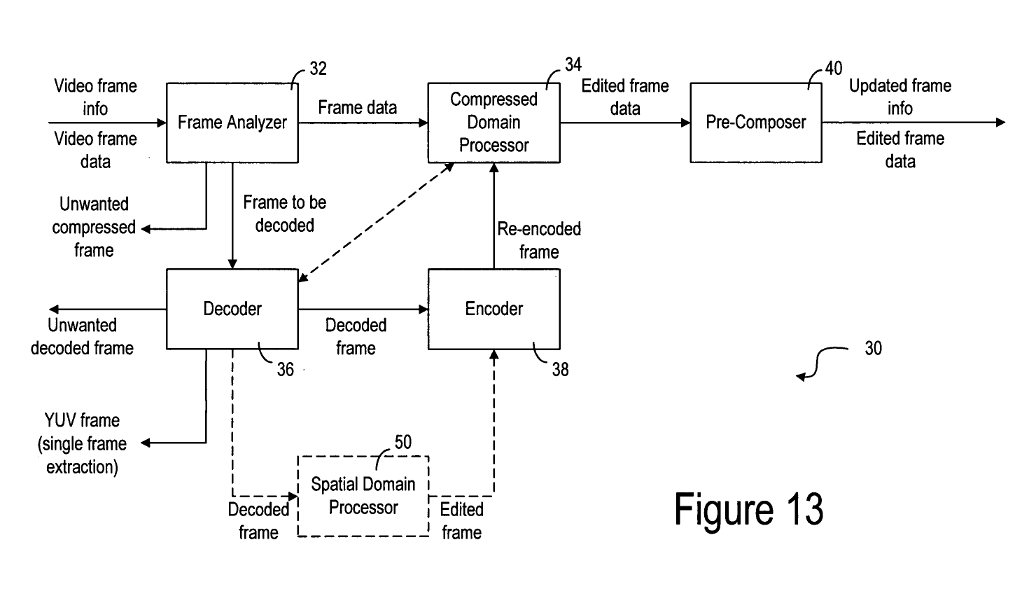

The video processor 30 takes in video frame data and its corresponding properties, along with the editing parameters (collectively denoted by reference numeral 120) to be applied on the media clip. The editing parameters are passed by the video editing engine 14 to the video editing processor module 18 in order to indicate the editing operation to be performed on the media clip. The video processor 30 takes these editing parameters and performs the editing operation on the video frame in the compressed domain. The output of the video processor is the edited video frame along with the frame properties, which are updated to reflect the changes in the edited video frame. The details of the video processor 30 are shown in FIG. 13. As shown, the video processor 30 consists of the following modules:

B.1. Frame Analyzer

The main function of the Frame Analyzer 32 is to look at the properties of the frame and determine the type of processing to be applied on it. Different frames of a video clip may undergo different types of processing, depending on the frame properties and the editing parameters. The Frame Analyzer makes the crucial decision of the type of processing to be applied on the particular frame. Different parts of the bitstream will be acted upon in different ways, depending on the frame characteristics of the bitstream and the specified editing parameters. Some portions of the bitstream are not included in the output movie, and will be thrown away. Some will be thrown away only after being decoded. Others will be re-encoded to convert from P- to I-frame. Some will be edited in the compressed domain and added to the output movie, while still others will be simply copied to the movie without any changes. It is the job of the Frame Analyzer to perform all these crucial decisions.

B.2. Compressed Domain Processor

The core processing of the frame in the compressed domain is performed in the compressed domain processor 34. The compressed video data is changed to apply the desired editing effect. This module can perform various different kinds of operations on the compressed data. One of the common ones among them is the application of the Black & White effect where a color frame is changed to a black & white frame by removing the chrominance data from the compressed video data. Other effects that can be performed by this module are the special effects (such as color filtering, sepia, etc.) and the transitional effects (such as fading in and fading out, etc.). Note that the module is not limited only to these effects, but can be used to perform all possible kinds of compressed domain editing.

Video data is usually VLC (variable-length code) coded. Hence, in order to perform the editing in the compressed domain, the data is first VLC decoded so that data can be represented in regular binary form. The binary data is then edited according to the desired effect, and the edited binary data is then VLC coded again to bring it back to compliant compressed form. Furthermore, some editing effects may require more than VLC decoding. For example, the data is first subjected to inverse quantization and/or IDCT (inverse discrete cosine transform) and then edited. The edited data is re-quantized and/or subjected to DCT operations to compliant compressed form.

B.3. Decoder

Although the present invention is concerned with compressed domain processing, there is still a need to decode frames. As shown in FIG. 13, the video processor 30 comprises a decoder 36, operatively connected to the frame analyzer 32 and the compressed domain processor 34, possibly via an encoder 38. If the beginning cut point in the input video falls on a P-frame, then this frame simply cannot be included in the output movie as a P-frame. The first frame of a video sequence must always start with an I-frame. Hence, there is a need to convert this P-frame to an I-frame.

In order to convert the P-frame to an I-frame, the frame must first be decoded. Moreover, since it is a P-frame, the decoding must start all the way back to the first I-frame preceding the beginning cut point. Hence, the relevant decoder is required to decode the frames by the decoder 36 from the preceding I-frame to the first included frame. This frame is then sent to the encoder 38 for re-encoding.

B.4. Spatial Domain Processor

It is possible to incorporate a spatial domain processor 50 in the compressed domain editing system, according to the present invention. The spatial domain processor 50 is used mainly in the situation where compressed domain processing of a particular frame is not possible. There may be some effects, special or transitional, that are not possible to apply directly to the compressed binary data. In such a situation, the frame is decoded and the effects are applied in the spatial domain. The edited frame is then sent to the encoder for re-encoding.

The Spatial Domain Processor 50 can be decomposed into two distinct modules: A Special Effects Processor and a Transitional Effects Processor. The Special Effects Processor is used to apply special effects on the frame (such as Old Movie effect, etc.). The Transitional Effects Processor is used to apply transitional effects on the frame (such as Slicing transitional effect, etc).

B.5. Encoder

If a frame is to be converted from P- to I-frame, or if some effect is to be applied on the frame in the spatial domain, then the frame is decoded by the decoder and the optional effect is applied in the spatial domain. The edited raw video frame is then sent to the encoder 38 where it is compressed back to the required type of frame (P- or I-), as shown in FIG. 13.

B.6. Pre-Composer

The main function of the Pre-Composer 40 as shown in FIG. 13 is to update the properties of the edited frame so that it is ready to be composed by the File Format Composer 80 (FIG. 12).

When a frame is edited in the compressed domain, the size of the frame changes. Moreover, the time duration and the time stamp of the frame may change. For example, if slow motion is applied on the video sequence, the time duration of the frame, as well as its time stamp, will change. Likewise, if the frame belongs to a video clip that is not the first video clip in the output movie, then the time stamp of the frame will be translated to adjust for the times of the first video clip, even though the individual time duration of the frame will not change.

If the frame is converted from a P-frame to an I-frame, then the type of the frame changes from inter to intra. Also, whenever a frame is decoded and re-encoded, it will likely cause a change in the coded size of the frame. All of these changes in the properties of the edited frame must be updated and reflected properly. The composer uses these frame properties to compose the output movie in the relevant file format. If the frame properties are not updated correctly, the movie cannot be composed.

C. Audio Processor

Video clips usually have audio embedded inside them. The audio processor 60, as shown in FIG. 12 is used to process the audio data in the input video clips in accordance with the editing parameters to generate the desired audio effect in the output movie.

Audio frames are generally shorter in duration than their corresponding video frames. Hence, more than one audio frame is generally included in the output movie for every video frame. Therefore, an adder is needed in the audio processor to gather all the audio frames corresponding to the particular video frame in the correct timing order. The processed audio frames are then sent to the composer for composing them in the output movie.

D. File Format Composer

Once the media frames (video, audio, etc.) have been edited and processed, they are sent to the File Format Composer 80, as shown in FIG. 12. The composer 80 receives the edited video 130 and audio frames 160, along with their respective frame properties, such as frame size, frame timestamps, frame type (e.g., P- or I-), etc. It then uses this frame information to compose and wrap the media frame data in the proper file format and with the proper video and audio timing information. The result is the final edited media file 180 in the relevant file format, playable in any compliant media player.

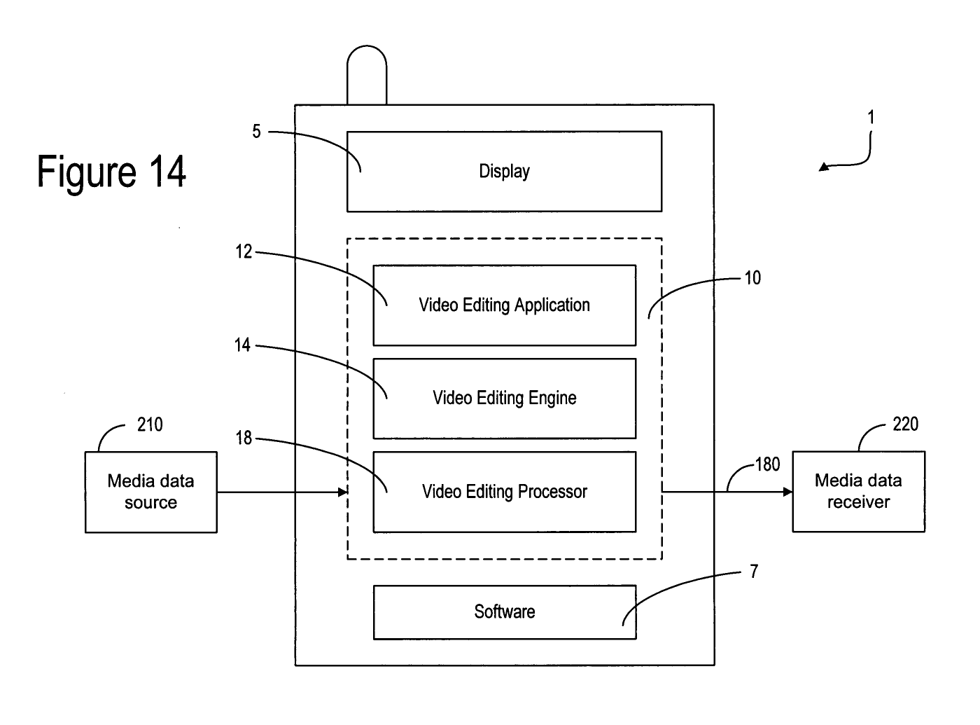

The present invention, as described above, provides an advantage that the need for computationally expensive operations like decoding and re-encoding can be at least partly avoided. FIG. 14 is a schematic representation of a device, which can be used for compressed-domain video editing, according to the present invention. As shown in FIG. 14, the device 1 comprises a display 5, which can be used to display a video image, for example. The device 1 also comprises a video editing system 10, including a video editing application 12, a video editing engine 12 and a video editing processor 18 as shown in FIG. 3. The video editing processor 18 receives input media file 100 from a media file source 210 and conveyed the output media file 180 to a media file receiver 220. The media file source 210 can be a video camera, which can be a part of the portable device 1. However, the media file source 210 can be a video receiver operatively connected to a video camera. The video receiver can be a part of the portable device. Furthermore, the media file source 210 can be a bitstream receiver, which is a part of the portable device, for receiving a bitstream indicative of the input media file. The edited media file 180 can be displayed on the display 5 of the portable device 1. However, the edited media file 180 can be conveyed to the media file receiver, such as a storage medium, a video transmitter. The storage medium and the video transmitter can also be part of the portable device. Moreover, the media file receiver 220 can also be an external display device. It should be noted the portable device 1 also comprises a software program 7 to carry out many of the compressed-domain editing procedures as described in conjunction with FIGS. 12 and 13. For example, the software program 7 can be used for file format parsing, file format composing, frame analysis and compressed domain frame processing.

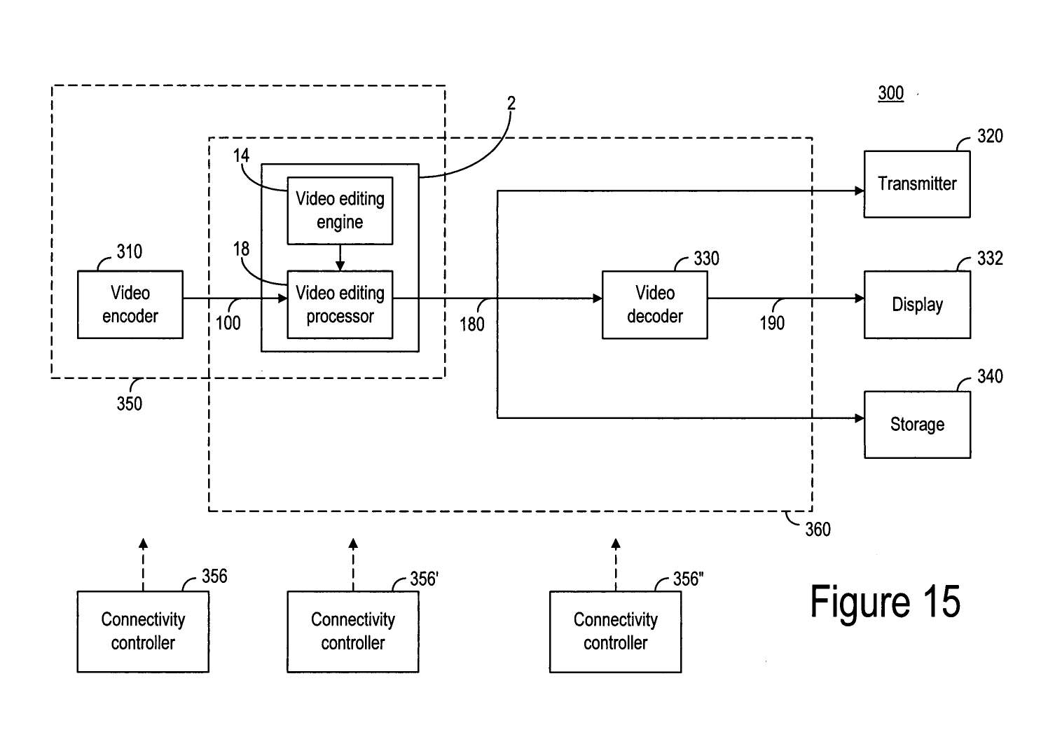

It should be noted that, the compressed domain video editing processor 18 of the present invention can be incorporated into a video coding system as shown in FIG. 15. As shown in FIG. 15, the coding system 300 comprises a video encoder 310, a video decoder 330 and a video editing system 2. The editing system 2 can be incorporated in a separate electronic device, such as the portable device 1 in FIG. 14. However, the editing system 2 can also be incorporated in a distributed coding system. For example, the editing system 2 can be implemented in an expanded decoder 360, along with the video decoder 330, so as to provide decoded video data 190 for displaying on a display device 332. Alternatively, the editing system 2 is implemented in an expanded encoder 350, along with the video encoder 310, so as to provide edited video data to a separate video decoder 330. The edited video data can also be conveyed to a transmitter 320 for transmission, or to a storage device 340 for storage.

Some or all of the components 2, 310, 320, 330, 332, 340, 350, 360 can be operatively connected to a connectivity controller 356 (or 356′, 356″) so that they can operate as remote-operable devices in one of many different ways, such as bluetooth, infra-red, wireless LAN. For example, the expanded encoder 350 can communicate with the video decoder 330 via wireless connection. Likewise, the editing system 2 can separately communicate with the video encoder 310 to receive data therefrom and with the video decoder 330 to provide data thereto.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in video editing for modifying at least one video frame in a video stream in order to achieve at least one video editing effect, the video editing carried out in a receiver receiving video data in the video stream, the receiver having a buffer for storing the received video data for decoding so as to allow the video stream to be played out, the buffer having a buffer fullness requirement, wherein the video data is received and played out based on a plurality of parameters such that the receiver buffer is prevented from violating of the buffer fullness requirement, and wherein the video editing effect affects the receiving and playing of the video data, said method comprising:
selecting at least one video editing effect; and
adjusting at least one of the parameters based on the selected at least one video editing effect so that video data is received and played out in compliance with the buffer fullness requirement, wherein said adjusting is carried out before modifying said one or more video frames in compressed domain for achieving the selected at least one video editing effect.

2. The method of claim 1, wherein said plurality of parameters include a transmission rate for transmitting the video data to the receiver receiving the video stream, and the selected editing effect is selected from a slow motion effect, a fast motion effect and a black-and-white effect, and wherein said adjusting comprises a modification in the transmission rate.

3. The method of claim 2, wherein the selected editing effect is achievable by decoding the stored video data at an adjusted decoding rate, and said modification in the transmission rate is at least partly based on the adjusted decoding rate.

4. The method of claim 1, wherein said plurality of parameters include a compressed frame size of the video frame, and the selected editing effect is selected from a black-and-white effect, a cutting effect, a merging effect and a fading effect, and wherein said adjusting comprises a modification in the compressed frame size.

5. The method of claim 4, wherein the selected editing effect is the merging effect achievable by adding video data to be merged into the video stream, wherein said modification is at least partly based on the added video data.

6. The method of claim 4, wherein the selected editing effect is the fading effect achievable by adding data of at least one color into the video stream, wherein said modification is at least partly based on the added video data.

7. The method of claim 4, wherein the selected editing effect is the black-and-white effect achievable by removing at least a portion of video data from the video stream, and wherein said modification is at least based on the removed portion of the video data.

8. A video editing module for use in an electronic device for changing at least one video frame in a video stream in order to achieve at least one video editing effect, the video stream including video data received in the electronic device, the electronic device having a buffer for storing the received video data for decoding so as to allow the video stream to be played out, the buffer having a buffer fullness requirement, wherein the video data is received and played out based on a plurality of parameters such that the buffer is prevented from violating the buffer fullness requirement, and wherein the video effect affects the receiving and playing of the video data, said module comprising:
a video editing engine, based on a selected video editing effect, for adjusting at least one of the parameters so that video data is received and played out in compliance with the buffer requirement, and
a compressed-domain processor, based on the selected video editing effect, for modifying said one or more video frames, wherein said adjusting is carried out before said modifying.

9. The video editing module according to claim 8, further comprising
a composing means, responsive to the modified one or more video frames, for providing video data in a file format for playout.

10. The video editing module of claim 8, wherein
said plurality of parameters include a transmission rate for transmitting the video data to the receiver receiving the video stream, the selected editing effect is selected from a slow motion effect, a fast motion effect and a black-and-white effect, and said adjusting comprises a modification in the transmission rate, and wherein
said plurality of parameters further include a compressed frame size of the video frame, and the selected editing effect is selected from a black-and-white effect, a cutting effect, a merging effect and a fading effect, and said adjusting comprises a modification in the compressed frame size.

11. A video editing system for use in an electronic device for changing at least one video frame in a video stream in order to achieve at least one video editing effect, the video stream including video data received in the electronic device, the electronic device having a buffer for storing the received video data for decoding so as to allow the video stream to be played out, the buffer having a buffer fullness requirement, wherein the video data is received and played out based on a plurality of parameters such that the buffer is prevented from violating the buffer fullness requirement, and wherein the video effect affects the receiving and playing of the video data, said system comprising:
means for selecting at least one video editing effect;
a video editing engine, based on the selected video editing effect, for adjusting at least one of the parameters so that video data is received and played out in compliance with the buffer requirement; and
a compressed-domain processor, based on the selected video editing effect, for modifying said one or more video frames, wherein said adjusting is carried out before said modifying.

12. The video editing system according to claim 11, further comprising
a composing module, responsive to the modified one or more video frames, for providing further video data in a file format for playout.

13. The video editing system of claim 11, wherein
said plurality of parameters include a transmission rate for transmitting the video data to the receiver receiving the video stream, the selected editing effect is selected from a slow motion effect, a fast motion effect and a black-and-white effect, and said adjusting comprises a modification in the transmission rate, and wherein
said plurality of parameters further include a compressed frame size of the video frame, and the selected editing effect is selected from a black-and-white effect, a cutting effect, a merging effect and a fading effect, and said adjusting comprises a modification in the compressed frame size.

14. The video editing module of claim 13, further comprising:
a software program, associated with the video editing engine, having codes for computing the transmission rate and the compressed frame size to be adjusted based on the selected video editing effect and current transmission rate and compressed frame size so as to allow the video editing engine to adjust said at least one of the parameters based on said computing.

15. A software product for use in video editing for modifying at least one video frame in a video stream in order to achieve at least one video editing effect, the video editing carried out in a receiver receiving video data in the video stream, the receiver having a buffer for storing the received video data for decoding so as to allow the video stream to be played out, the buffer having a buffer fullness requirement, wherein the video data is received and played out based on a plurality of parameters such that the receiver buffer is prevented from violating the buffer fullness requirement, said plurality of parameters including a transmission rate and a compressed frame size, and wherein the video editing effect affects the receiving and playing of the video data, the software product comprising a computer readable medium having executable codes embedded therein, said codes, when executed, adapted for:
computing at least one of the parameters to be adjusted for conforming with the buffer fullness requirement based on a selected video editing effect and on current transmission rate and compressed frame size, and
providing said computed parameter so that the video data is received and played out at least based on said computed parameters before modifying said one or more video frames in compressed domain for achieving the selected at least one video editing effect.

16. An electronic device comprising:
means for receiving a video stream having video data included in a plurality of video frames;
a buffer for storing the received video data for decoding so as to allow the video stream to be played out, the buffer having a buffer fullness requirement;
a video editing module for modifying at least one video frame in the video stream in compressed domain in order to achieve at least one selected video editing effect, wherein the video data is received and played out based on a plurality of parameters such that the buffer is prevented from violating the buffer fullness requirement, and wherein the video effect affects the receiving and playing of the video data, and
means, based on the selected video editing effect, for computing at least one of the parameters to be adjusted so that video data is received and played out in compliance with the buffer fullness requirement, wherein the adjustment of said at least one of the parameters is carried out before said modifying.

17. The device of claim 16, wherein said plurality of parameters include a transmission rate for transmitting the video data to the receiver receiving the video stream, and the selected editing effect is selected from a slow motion effect, a fast motion effect and a black-and-white effect, and wherein said adjusting comprises a modification in the transmission rate.

18. The device of claim 17, wherein the selected editing effect is achievable by decoding the stored video data at an adjusted decoding rate, and said modification in the transmission rate is at least partly based on the adjusted decoding rate.

19. The device of claim 16, wherein said plurality of parameters include a compressed frame size of the video frame, and the selected editing effect is selected from a black-and-white effect, a cutting effect, a merging effect and a fading effect, and wherein said adjusting comprises a modification in the compressed frame size.

20. The device of claim 19, wherein the selected editing effect is the merging effect achievable by adding video data to be merged into the video stream, wherein said modification is at least partly based on the added video data.

21. The device of claim 19, wherein the selected editing effect is the fading effect achievable by adding data of at least one color into the video stream, wherein said modification is at least partly based on the added video data.

22. The device of claim 19, wherein the selected editing effect is the black-and-white effect achievable by removing at least a portion of video data from the video stream, and wherein said modification is at least based on the removed portion of the video data.
